(19) United States
(12) Patent Application Publication
(10) Pub. No.: US 2018/0356787 A1
(43) Pub. Date: Dec. 13, 2018

(54) VISUAL INSPECTION METHOD FOR VERIFYING MATERIAL PRESENCE

(71) Applicant: GM GLOBAL TECHNOLOGY OPERATIONS LLC, Detroit, MI (US)

(72) Inventors: Matthew P. Simonin, Ortonville, MI (US); Robert N. Saje, Shelby Township, MI (US); Bhavesh Shah, Troy, MI (US)

(73) Assignee: GM GLOBAL TECHNOLOGY OPERATIONS LLC, Detroit, MI (US)

(21) Appl. No.: 15/620,312

(22) Filed: Jun. 12, 2017

(51) Int. Cl. G05B 19/401

(52) U.S. Cl. CPC G05B 19/401; G06K 9/24

(57) ABSTRACT

A visual inspection method includes the following steps: (a) placing a material between a pair of parts, wherein at least one of the pair of parts defines at least one thru-hole sized to partly receive the material; (b) pressing the pair of parts together until the material is partly displaced into the thru-hole (or merely moving the pair of parts toward each other until the material is partly displaced into the thru-hole); and (c) visually inspecting the one thru-hole to verify that the material is partly disposed in the thru-hole after pressing the pair of parts together (or moving the pair of parts toward each other).

### INTRODUCTION

The present disclosure relates to a visual inspection method for verifying the presence of material, such as structural adhesive or sealer, after assembling multiple parts together. The presently disclosed method could eliminate the need to perform verification with techniques such as ultrasonic scanning or destructive teardown.

Parts, such as vehicle parts, may be coupled to each other with a material. Therefore, it is desirable to develop a method for verifying the presence of material.

### SUMMARY

Material may be for assembling parts. In the present disclosure, the term “material” means an adhesive or a sealer. For example, materials can be used to adhere vehicle parts. To couple two or more parts together, the material may be placed between the parts. Then, the parts may be assembled together. After the parts are assembled together, it is desirable to verify the presence of material between the parts. To this end, the present disclosure describes a visual inspection method for verifying the presence of material, such as structural adhesive or sealer, after assembling multiple parts together.

In certain embodiments, the method includes the following steps: (a) placing a material between a pair of parts, wherein at least one of the pair of parts defines at least one thru-hole sized to partly receive the material; (b) pressing the pair of parts together until the material is partly displaced into the thru-hole (or merely moving the pair of parts toward each other until the material is partly displaced into the thru-hole); and (c) visually inspecting the one thru-hole to verify that the material is partly disposed in the thru-hole after pressing the pair of parts together (or moving the pair of parts toward each other). By employing this method, a person can verify the presence of the material at the appropriate location between the parts by seeing the material within the thru-hole (i.e., witness hole) or squeezed out of the thru-hole.

To verify the presence of the material between the pair of parts, the inspector may look within the thru-hole. In certain embodiments, the pair of parts may be pressed together until the material is squeezed out of the thru-hole. In this case, the visual inspection may entail seeing that the material squeezed out of the thru-hole. In certain embodiments, the method may further include forming the thru-hole in one of the pair of parts before placing the material between the pair of parts. A drill or any other suitable tool can be used to form the thru-hole. For example, a CNC machine can be used to drill the thru-holes 18 into composites, castings, and the like. Alternatively, the thru-holes 18 can be formed by piercing at least one of the parts 11. Also, the thru-holes 18 can be formed by laser cutting the parts 11. The pair of parts may be designed as a first part and a second part. The method may include forming the thru-hole (i.e., a first thru-hole) in the second part. Thus, the method may entail visually inspecting the first thru-hole in the second part. The method may further include forming a second thru-hole in the second part. Accordingly, the second thru-hole may also be visually inspected to verify the presence of the material between the pair of parts. The method may further include forming a third thru-hole in the first part. Accordingly, the method may include visually inspecting the third thru-hole in the first part. The method may also include forming a fourth thru-hole in the first part, and visually inspecting the fourth thru-hole in the first part. The pair of parts may be vehicle parts.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic cross-sectional side view of a coupling assembly.

FIG. 2 is a schematic cross-sectional side view of a coupling assembly according to another aspect of the present disclosure.

FIG. 3 is a schematic cross-sectional side view of a coupling assembly according to another aspect of the present disclosure.

FIG. 4 is a schematic cross-sectional side view of a coupling assembly according to another aspect of the present disclosure.

FIG. 5 is a schematic cross-sectional top view of a coupling assembly according to another aspect of the present disclosure.

FIG. 6 is a schematic cross-sectional side view of the coupling assembly shown in FIG. 5.

FIG. 7 is a schematic top view of a vehicle body including a coupling assembly.

FIG. 8 is a schematic cross-sectional side view of the vehicle body shown in FIG. 7, taken along the section line 8-8 of FIG. 7.

FIG. 9 is a flowchart of a visual inspection method for verifying the presence of a material, such as structural adhesive or sealer, after assembling multiple parts together.

### DETAILED DESCRIPTION

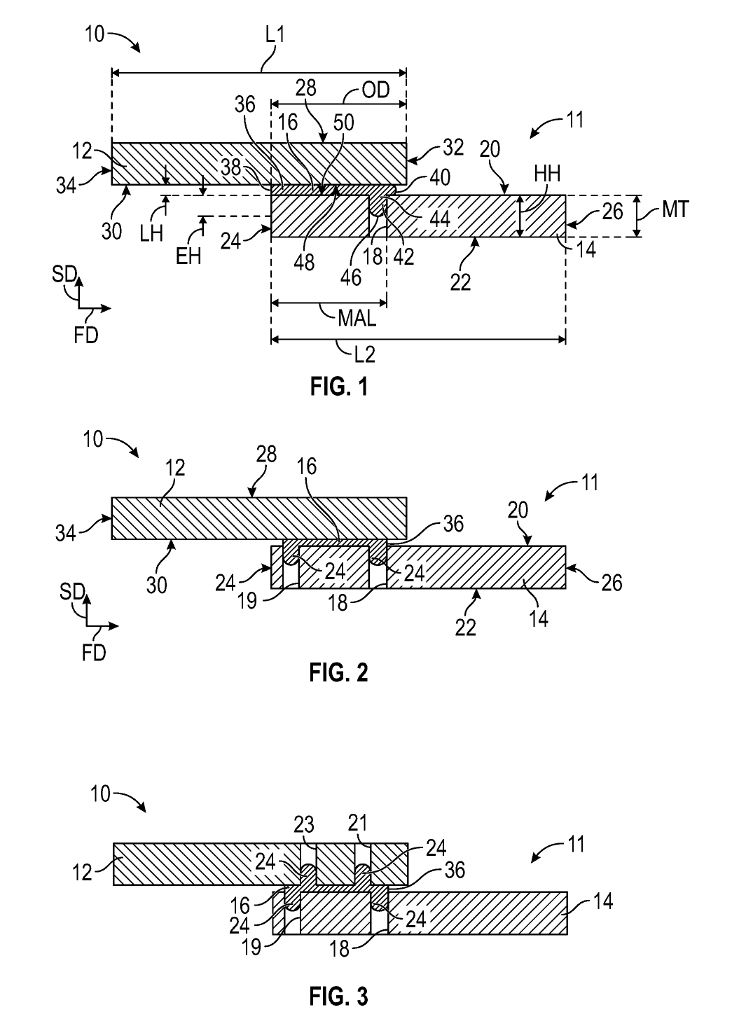

As discussed above, the present disclosure describes a visual inspection method for verifying the presence of material, such as structural adhesive or sealer, after assembling multiple parts together. Before describing the method in detail, the structural details associated with the presently disclosed method are described below. While the present disclosure describes the structural features of a coupling assembly 10 (FIG. 1) in greater detail, it is contemplated that the presently disclosed visual inspection method may be used with other coupling assemblies.

With reference to FIG. 1, a coupling assembly 10 includes a pair of parts 11 and a material 16 disposed between the pair of body parts 11. As a non-limiting example, the pair of parts 11 may be flanges. Specifically, the coupling assembly 10 includes a first part 12 and a second part 14 (i.e., the pair of parts 11). The material 16 may couple the first part 12 to the second part 14. For example, the material 16 may adhere the part of parts 11 together. Thus, the material 16 may be an adhesive for adhering the pair of parts together. Suitable adhesives include, but are not limited to, an anaerobic adhesive, a cyanoacrylate, a heat curing adhesive, an epoxy resin, a phenol-formaldehyde adhesive, a polyurethane adhesive, a moisture curing adhesive, a radiating curing adhesive, a silicone adhesive, and a methyl methacrylate (MMA) adhesive. Further, the material 16 may be a sealant for blocking the passage of fluid between the pair of parts 11.

The first part 12 and the second part 14 may be wholly or partly made of a substantially rigid material. For example, the first part 12 and the second part 14 may be wholly or partly made of a rigid thermoset and/or a rigid thermoplastic. It is contemplated that the first part 12 and the second part 14 may also be wholly or partly made of a rigid metallic material, such as stainless steel. Regardless of the specific material employed for the pair of parts 11, the material 16 should be placed between the pair of parts 11 together. At least one of the pair of parts 11 defines a thru-hole 18. The thru-hole 18 is configured to partly receive the material 16 to allow the user to verify the presence of material 16 at the appropriate location between the pair of parts 11. Therefore, the thru-hole 18 is sized and shape to receive sufficient amount of material 16 to allow visual inspection of the material 16. In other words, the thru-hole 18 allows wet-out verifications checks from the top or bottom of the coupling assembly 10. In doing so, the thru-hole 18 allows a manufacturer or quality assurance specialist to verify whether or not the material 16 is present between at interface between the first part 12 and the second part 14.

In the embodiment depicted in FIG. 1, the second part 14 defines the thru-hole 18. Specifically, in this embodiment, the second part 14 has a single thru-hole 18 to facilitate manufacturing. It is envisioned, however, that the second part 14 may have one or more thru-holes 18 depending on the material needs of the coupling assembly 10. The second part 14 may be elongated along a first direction FD. Further, the second part 14 has a first or inner part surface 20 and a second or outer part surface 22 opposite the first part surface 20. The first part surface 20 is spaced apart from the second part surface 22 along a second direction SD. The second direction SD is perpendicular to the first direction FD. The thru-hole 18 is elongated along the second direction SD and, therefore, extends from the first part surface 20 to the second part surface 22 of the second part 22. The second part 22 may further have a third part surface 24 and a fourth part surface 26 opposite the third part surface 24. The third part surface 24 may directly interconnect the first part surface 20 and the second part surface 22. In the depicted embodiment, the third part surface 24 is perpendicular to the first part surface 20 and the second part surface 22. It is contemplated, however, that the third part surface 24 may be obliquely angled relative to the first part surface 20 and/or the second part surface 22. In the depicted embodiment, the first part surface 20 faces toward the first part 12, and the second part surface 22 faces away from the first part 12. The thru-hole 18 may be sized to receive enough material 16 to allow visual inspection of the material 16. The fourth part surface 26 may also directly interconnect the first part surface 20 and the second part surface 22. Further, the fourth part surface 26 may be perpendicular to the first part surface 20 and the second part surface 22. However, the fourth part surface 22 may be obliquely angled relative to the first part surface 20 and/or the second part surface 22.

The first part 12 has a first body surface 28 and a second body surface 30 opposite the first body surface 28. The first body surface 28 is spaced apart from the second body surface 30 along the second direction SD. The second body surface 30 faces toward the second part 14, and the first body surface 28 faces away from the second part 14. The first part 12 also has a third body surface 32 and a fourth body surface 34 opposite the third body surface 32. The fourth body surface 34 is spaced apart from the third body surface 32 along the first direction FD. The fourth body surface 34 may also directly interconnect the first body surface 28 and the second body surface 30. The third body surface 32 and the fourth body surface 34 may each be perpendicular to the first body surface 28 and/or the second body surface 30. However, the third body surface 32 and/or the fourth body surface 34 may be obliquely angled relative to the first body surface 28 and/or the second body surface 30. In this embodiment, the first body surface 28 and the third body surface 32 are visible to the assembler. Thus, the thru-hole 18 is sized to receive enough material 16 to allow visual inspection of the presence of the material 16. In this embodiment, the first part 12 does not include thru-holes (or any other kind of holes, such as a blind hole) to facilitate manufacturing.

The first part 12 has a first length L1. The first length L1 is a distance from the third body surface 32 to the fourth body surface 34 along the first direction FD. The second part has a second length L2. The second length is a distance deform the third part surface 24 to the fourth part surface 26 along the first direction FD. The first part 12 and the second part 14 overlap each other along an overlapping distance OD. The overlapping distance OD is a distance from the third body surface 32 of the first part 12 to the third part surface 24 of the second part 14 along the first direction FD. The first length L1 is greater than the overlapping distance OD to avoid material squeeze out. The second length L2 may greater than the overlapping distance OD.

The material 16 includes a continuous material layer 36. The continuous material layer 36 has a first material terminus 38 and a second material terminus 40 opposite the first material terminus 38. The first material terminus 38 is spaced apart from the second material terminus 40 along the first direction FD. The maximum length MAL of the material 16 (i.e., the maximum material length) is a distance from the first material terminus 38 to the second material terminus 40 along the first direction FD. The first material terminus 38 is closer to the third body surface 32 of the first part 12 than to the third part surface 24 of the second part 14. The second material terminus 40 is closer to the third part surface 24 of the second part 14 than to the third body surface 34 of the first part 12.

The material 16 also includes a material extension 42 protruding directly from the material layer 36. The material extension 24 has a first extension end 44 and a second extension end 46 opposite the first extension end 44. The first extension end 44 is directly coupled to the material layer 36. The second extension end 46 is spaced apart from the first extension end 44 along the second direction SD. The material extension 24 has a maximum extension height EH. The maximum extension height EH is a distance from the first extension end 44 to the second extension end 46 along the second direction SD. The maximum extension height EH may be greater than the maximum thickness MT of the second part 14.

The material layer 38 has a first material surface 48 and a second material surface 50 opposite the first material layer 48. The first material surface 48 is spaced apart from the second material surface 50 along the second direction SD. The material layer 38 has a maximum layer height LH. The maximum layer height LH is a distance from the first material surface 48 to the second material surface 50 along the second direction SD. The maximum layer height LH may be less than the maximum extension height EH. The first material surface 48 may be in direct contact the second body surface 30 of the first part 12 to enhance bonding between the first part 12 and the material 16, and the second material surface 50 may be in direct contact with the first part surface 20 of the second part 14 to enhance bonding between the second part 14 and the material 16.

The second part 14 defines a maximum thickness MT. The maximum thickness MT is a distance from the first part surface 20 to the second part surface 22 along the second direction SD. The thru-hole 18 has a maximum hole height, the maximum hole height is equal to the maximum thickness of the second part. The maximum extension height EH is less than the maximum hole height HH. However, the maximum extension height EH may be greater than the maximum hole height HH to facility visual inspection of the material 16. The maximum hole height HH is equal to the maximum thickness MT of the second part 14 to allow the thru-hole 18 to extend through the entire maximum thickness MT of the second part 14. As discussed above, the thru-hole 18 allows a manufacturer or quality assurance specialist to verify whether or not the material 16 is present at the interface of the first part 12 and the second part 14.

With reference to FIG. 2, in certain embodiments, the second part 14 of coupling assembly 10 may two thru-holes (i.e., the thru-hole 18 and a thru-hole 19). The thru-hole 18 may be referred to as the first thru-hole 18, and the thru-hole 18 may be referred to as the second thru-hole 19. As such, the second part 14 defines the first thru-hole 18 and the second thru-hole 19. It may be desirable to include two thru-holes (i.e., the first thru-hole 18 and the second thru-hole 19) in the second part 14 to ensure that the material 16 covers an expanded predetermined area at the interface of the first part 12 and the second part 14. In other words, the first thru-hole 18 and the second thru-hole 19 allows for wet-out verification checks. Also, the first thru-hole 18 and the second thru-hole 19 provides a path for the excess of material 16 when pressing the first part 12 and the second part 14 together. The first thru-hole 18 and the second thru-hole 19 may be located in the second part 14 (instead of the first part 12), because the first body surface 28 of the first part 12 may be visible to the customer and, therefore, adding thru-holes to the first part 12 may not be aesthetically pleasing. Thus, in this embodiment, the first body surface 28 of the first part 12 is visible to the customer and, therefore, the first part 12 does not include thru-holes. In this embodiment, the material 16 includes two material extensions 42 each in a different thru-hole (i.e., the first thru-hole 18 and the second thru-hole 19). Each of the material extensions 42 protrudes directly from the material layer 36, thereby allowing visual inspection for the material 16.

With reference to FIG. 3, in certain embodiments, the first part 12 of coupling assembly 10 may two thru-holes (i.e., the third thru-hole 21 and a fourth thru-hole 23). Thus, the coupling assembly 10 includes the first thru-hole 18 and the third thru-hole 21, which extend through the second part 14, and the third thru-hole 21 and the fourth thru-hole 23, which extend through the first part 12. The fourth thru-hole 23 is spaced apart from the third thru-hole 21 along the first direction FD, allowing an inspector to verify the surface area (or at least length) covered by the material 16 at the interface between the first part 12 and the second part 14. Accordingly, both the first part 12 and the second part 14 may include thru-holes for wet-out verification checks. In this embodiment, the material 16 includes four material extensions 42 each in a different thru-hole (i.e., the first thru-hole 18, the second thru-hole 19, the third thru-hole 21, and the fourth thru-hole 23). Each of the material extensions 42 protrudes directly from the material layer 36, thereby allowing visual inspection of the material 16.

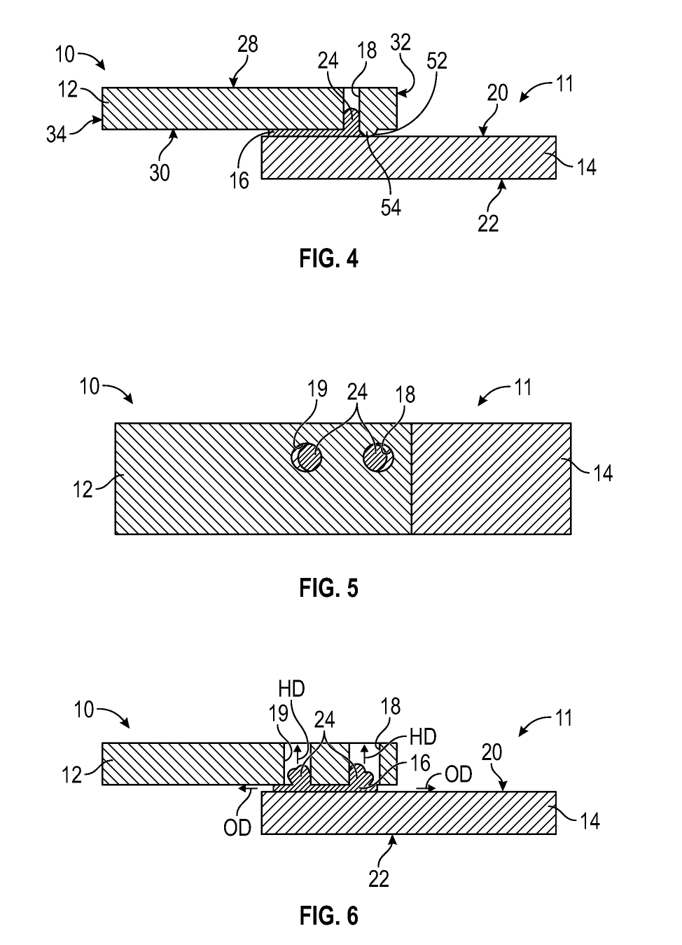

With reference to FIG. 4, in certain embodiments, the first part 12 and/or the second part 14 may include a mechanical stop 52. The mechanical stop 52 may be direct contact with the material 16 and protrudes directly from the second body surface 30 toward the second part 14. In the depicted embodiment, the mechanical stop 52 is a protrusion 54 extending directly from the second body surface 30 of the first part 12. The mechanical stop 52 may be in direct contact with the second part 14. Specifically, the mechanical stop 52 may be in direct contact with the first part surface 20 of the second part 14. In this embodiment, the thru-hole 18 is in the first part 12, and the thru-hole 18 allows the material 16 to reach the mechanical stop 52. For this reason, the thru-hole 18 is closer to the mechanical stop 52 than to the third body surface 32 and the fourth body surface 34 of the first part 12.

With reference to FIGS. 5 and 6, instead of the second part 14, the first part 12 may define the first thru-hole 18 and the second thru-hole 19 when the first part surface 20 and/or the second part surface 22 of the second part 14 are visible to the customer in order to maintain an aesthetically pleasing appearance.

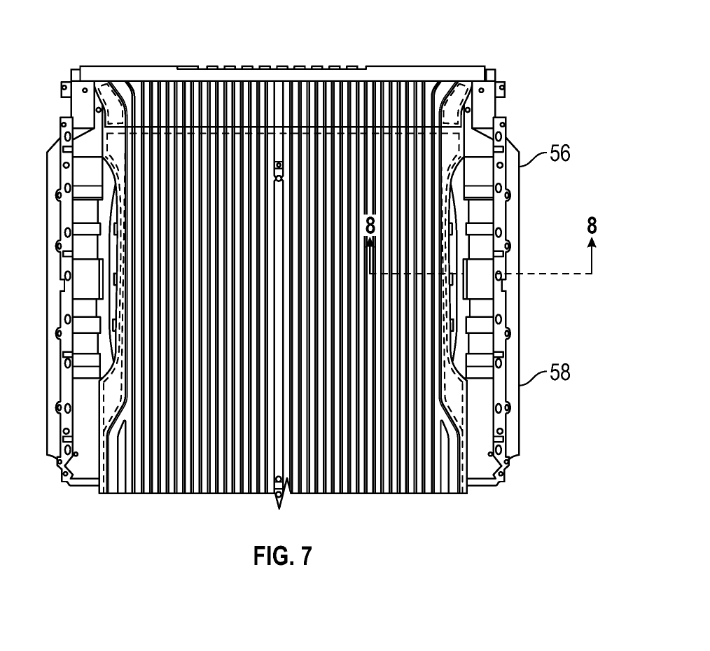

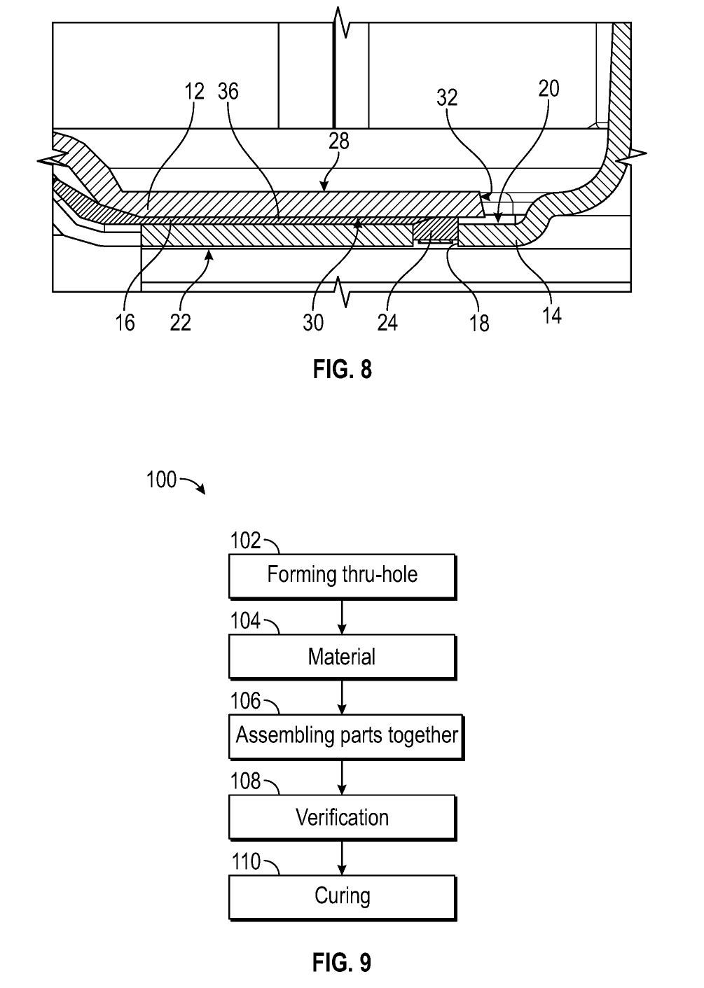

With reference to FIGS. 7 and 8, the first part 12 and the second part 14 may be part of a vehicle body 56. Accordingly, the first part 12 and the second part 14 may be vehicle parts. In this embodiment, the vehicle body 56 includes a pickup truck bed 58. Thus, the vehicle body 56 includes the first part 12, the second part 14, and one or more thru-holes 18 extending through the first part 12 and/or the second part 14. The vehicle body 56 may be configured as any of the embodiments described above. For example, the first part 12 and/or the second part 14 may also include the mechanical stop 52 (FIG. 4). In the depicted embodiment, at least the first part surface 20 of the second part 14 is visible to the customer, and the material 16 does not extend beyond the third body surface 32 of the first part 12 to enhance the visual appearance of the vehicle body 56.

With reference to FIG. 9, the present disclosure relates to a visual inspection method 100 for verifying the presence of material 16, such as structural adhesive or sealer, after assembling multiple parts 11 together. In certain embodiments, the method 100 includes one or more of the following steps. At step 102, one or more thru-holes (e.g., thru-hole 18 in FIG. 1) in the first part 12 and/or the second part 14. A drill or any other suitable tool can be used to form the thru-holes. For example, a CNC machine can be used to drill the thru-holes 18 into composites, castings, and the like. Alternatively, the thru-holes 18 can be formed by piercing the parts 11. Also, the thru-holes 18 can be formed by laser cutting the parts 11. The thru-holes 18 are formed before assembling the parts 11. The method 100 may entail forming the first thru-hole 18 and/or the second thru-hole 19 in the second part 14. The method 100 may further include forming the third thru-hole 21 and/or the fourth thru-hole 23 in the first part 12. As discussed above, each of the thru-holes are sized to partly receive the material 16 (FIG. 1). Step 102 is optional, because the first part 12 and/or the second part 14 may already have the thru-holes. Afterwards, the method 100 proceeds to step 104.

At step 104, the pre-cured material 16 (FIG. 6) is placed between the pair of parts 11 (i.e., the first part 12 and the second part 14) to adhere the pair of parts 11 together or to seal the interface between the parts 11. For example, the pre-cured material 16 may be pumped between the pair of parts 11. Alternatively, the pre-cured material may be applied with die cut patches. The material 16 is disposed between the pair of parts 11 before assembling the parts 11. Then, at step 106, before the material 16 is completely cured, the pair of parts 11 (i.e., the first part 12 and the second part 14) are moved toward each other together until the material 16 is partly displaced into the thru-hole (or thru-holes). Alternatively, the pair of parts 11 are merely moving toward each other until the material 16 is partly displaced into the thru-hole(s). As the pair of parts 11 are moved toward each other, the pre-cured material 16 moves in the outward direction OD as shown in FIG. 6, and some of the material 16 is displaced through the thru-hole (or thru-holes, such as thru-holes 18 and 19) in the direction indicated by HD as shown in FIG. 6. In some embodiments, the pair of parts (i.e., the first part 12 and the second part 14) are pressed together until the mechanical stop 52 (FIG. 4) is in direct contact with the first part surface 20 of the second part 14. Then, the method 100 proceeds to step 108. In certain embodiments, the pair of parts 11 may be pressed together (or moved toward each other) until the material 16 is squeezed out of at least one of the thru-holes.

At step 108, an inspector looks through at least one thru-hole (e.g., thru-hole 18) as shown in FIG. 5 to verify that the material 16 is partly disposed in the thru-hole after pressing the pair of parts together, thereby allowing the inspector to verify the surface area (or at least length) covered by the material 16 at the interface between the first part 12 and the second part 14. In other words, the method 100 entails visually inspecting at least one thru-hole 18 to verify that the material 16 is partly disposed in the thru-hole 18 after pressing the pair of parts 11 together (or moving the pair of parts 11 toward each other). For example, the method 100 may entail visually inspecting the first thru-hole 18, the second thru-hole 19, the third thru-hole 21, and/or the fourth thru-hole 23. To verify the presence of the material 16 between the pair of parts 11, the inspector may look within one or more of the thru-holes 18. In certain embodiments, the visual inspection may entail seeing that the material squeezed out of the thru-hole. The material 16 should cover a predetermined surface area to ensure proper bonding or sealing between the first part 12 and the second part 14. Then, the method 100 proceeds to step 110. At step 110, the material 16 is completely cured through, for example, cooling or heating, to adhere the first part 12 to the second part 14 or to seal the interface between the first part 12 and the second part 14.

While the best modes for carrying out the disclosure have been described in detail, those familiar with the art to which this disclosure relates will recognize various alternative designs and embodiments for practicing the disclosure within the scope of the appended claims.

What is claimed is:

1. A method, comprising:
placing a material between a pair of parts, wherein at least one of the pair of parts defines at least one thru-hole sized to partly receive the material;
moving the pair of parts toward each other until the material is at least partly displaced into the at least one thru-hole; and
visually inspecting the at least one thru-hole to verify that the material is partly disposed in the thru-hole after pressing the pair of parts together.

2. The method of claim 1, wherein visually inspecting includes looking within the at least one thru-hole to verify a presence of material within the at least one thru-hole.

3. The method of claim 1, wherein pressing pair of parts together includes pressing the pair of part together until the material is squeezed out of the at least one thru-hole.

4. The method of claim 3, wherein visually inspecting the at least one thru-hole includes seeing the material squeezed out of the at least one thru-hole.

5. The method of claim 1, further forming the at least one thru-hole in at least one of the pair of parts before placing the material between the pair of parts.

6. The method of claim 5, wherein the pair of parts includes a first part and a second part, the at least one thru-hole includes a first thru-hole, and forming the at least one thru-hole includes forming the first thru-hole in the second part.

7. The method of claim 6, wherein visually inspecting the at least one thru-hole includes visually inspecting the first thru-hole in the second part.

8. The method of claim 7, wherein the at least one thru-hole includes a second thru-hole, and forming the at least one thru-hole includes forming the second thru-hole in the second part.

9. The method of claim 8, wherein visually inspecting the at least one thru-hole includes visually inspecting the second thru-hole in the second part.

10. The method of claim 9, wherein the at least one thru-hole includes a third thru-hole, and forming the at least one thru-hole includes forming the third thru-hole in the first part.

11. The method of claim 10, wherein visually inspecting the at least one thru-hole includes visually inspecting the third thru-hole in the first part.

12. The method of claim 11, wherein the at least one thru-hole includes a fourth thru-hole, and forming the at least one thru-hole includes forming the fourth thru-hole in the first part.

13. The method of claim 12, wherein visually inspecting the at least one thru-hole includes visually inspecting the fourth thru-hole in the first part.

14. The method of claim 1, wherein the pair of parts are vehicle parts.

15. A method for verifying a presence of a material between a pair of parts, comprising:
moving the pair of parts toward each other until the material is at least partly displaced into at least one thru-hole, wherein the at least one thru-hole extends through one of the pair of parts; and
visually inspecting the at least one thru-hole to verify that the material is partly disposed in the thru-hole after pressing the pair of parts together.

16. The method of claim 15, wherein visually inspecting includes looking within the at least one thru-hole to verify the presence of the material within the at least one thru-hole.

17. The method of claim 15, wherein moving the pair of parts toward each other includes moving the pair of parts toward each other until the material is squeezed out of the at least one thru-hole.

18. The method of claim 17, wherein visually inspecting the at least one thru-hole includes seeing material squeezed out of the at least one thru-hole.

19. The method of claim 15, further forming the at least one thru-hole in at least one of the pair of parts before placing the material between the pair of parts.

20. The method of claim 19, wherein the pair of parts includes a first part and a second part, the at least one thru-hole includes a first thru-hole, and forming the at least one thru-hole includes forming the first thru-hole in the second part.
